(19) United States
(12) Patent Application Publication
(10) Pub. No.: US 2021/0081070 A1
(43) Pub. Date: Mar. 18, 2021

(54) TOUCH DRIVING METHOD

(71) Applicant: Shenzhen China Star Optoelectronics Technology Co., Ltd., Shenzhen (CN)

(72) Inventors: Huiyang Kang, Shenzhen (CN); Mingwei Chen, Shenzhen (CN); Wendong Li, Shenzhen (CN); Lei Chen, Shenzhen (CN)

(73) Assignee: Shenzhen China Star Optoelectronics Technology Co., Ltd., Shenzhen (CN)

(21) Appl. No.: 16/307,471

(22) PCT Filed: Sep. 27, 2018
(86) PCT No.: PCT/CN2018/107824

§ 371 Date: Dec. 5, 2018

(30) Foreign Application Priority Data
Jul. 17, 2018 (CN) 201810785486.2

(51) Int. Cl. G06F 3/041; G06F 3/044

(52) U.S. Cl. CPC G06F 3/0418; G06F 3/0446

(57) ABSTRACT

The present invention provides a method for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the method comprising: concurrently providing a sine wave driving signal to at least one of the first electrodes; and sensing the sine wave driving signal via the multiple second electrodes, wherein the multiple pixel horizontal axes are refreshed sequentially during the time interval of providing sine wave driving signal.

### FIELD OF THE INVENTION

The present disclosure relates to a touch driving field, and more particularly to a touch driving method.

### BACKGROUND OF THE INVENTION

With the development of electronic portable display devices, the touch panel having the touch function is widely used. The touch panel can be inputted via finger and stylus, such that operation can be easy and convenient.

The touch panel has four types: resistive, capacitive, optics, and surface acoustic wave in accordance with sensing technology, wherein the capacitive touch panel is mainly used. The capacitive type can be divided into self-capacitance type and mutual capacitance type. Nowadays, the capacitive touch panel in the market is mainly the mutual capacitance type, which has the advantage to realize multi-touch.

Referring to FIG. 1, the capacitive touch panel usually includes a plurality of touch driving electrodes 100 extended along the horizontal direction, and a plurality of touch receiving electrodes 200 extended along the vertical direction, wherein the touch driving electrodes 100 and the touch receiving electrodes 200 are insulated with each other. Due that the body of human being may have moisture and is the excellent electric conductor, the capacitance between the finger and electrode may increase if the human body touches the touch panel. In this moment, the touch control integrated chip (IC) in the touch panel can output the touch driving signals Tx′(m)(m=1, 2, 3, 4, 5 . . . ) to the touch driving electrodes 100, and can control the touch receiving electrodes 200 to receive the touch sensing signals Rx′(n)(n=1, 2, 3, 4, 5 . . . ). By sensing the touch sensing signals Rx′(n) to investigate which static capacitance of the coordination is increased, the specific coordination of the touch can be obtained. In the conventional technology, the touch driving signals Tx′(m) outputted by the touch control IC is in a form of square wave.

Referring to FIGS. 1 and 2, to increase anti-interference capability of the touch panel, the touch control IC can apply a composite process to the touch driving signals Tx′(m): every four adjacent touch driving signals Tx′(m) are configured to be a signal package. The four touch driving signals Tx′(1), Tx′(2), Tx′(3), and Tx′(4) within the same signal package are outputted in a form of square wave, and the four touch driving signals Tx′(1), Tx′(2), Tx′(3), and Tx′(4) within the signal package are sequentially configured to be 4 stages: a first stage S(1)′, a second stage S(2)′, a third stage S(3)′, and a fourth stage S(4)′ along a timeline. In the first stage S(1)′, the phase of first touch driving signals Tx′(1) is opposite to the other touch driving signals Tx′(2), Tx′(3), and Tx′(4) within the signal package. In the second stage S(2)′, the phase of the second touch driving signals Tx′(2) is opposite to the phases of the other touch driving signals Tx′(1), Tx′(3), and Tx′(4) within the signal package. In the third stage S(3)′, the phase of the third touch driving signals Tx′(3) is opposite to the phases of the other touch driving signals Tx′(1), Tx′(2), and Tx′(4) within the signal package. In the fourth stage S(4)′, the phase of the fourth touch driving signals Tx′(4) is opposite to the phases of the other touch driving signals Tx′(1), Tx′(2), and Tx′(3) within the signal package.

As shown in FIG. 3, the square wave is overlapped by a plurality of sine wave of various different frequencies and various different amplitudes after Fourier transform, and are easily interfered by the harmonic wave. Therefore, even if the driving IC applies a composite process to the touch driving signals Tx′(m) as shown in FIG. 2, the touch driving signals Tx′(m) can easily generate radiation and electromagnetic interference.

### SUMMARY OF THE INVENTION

The present disclosure relates to a touch driving method, avoiding increasing the cost of touch panel, to reduce the touch driving signals from generating radiation and electromagnetic interference, so as to increase anti-interference capability of the touch panel.

In one aspect, a touch driving method is provided. The touch diving method includes: step S1: providing a touch panel; wherein the touch panel includes a plurality of touch driving electrodes being spaced apart from each other; a plurality of touch sensing electrodes being spaced apart from each other; and a touch control integrated chip (IC); wherein the touch driving electrodes and the touch sensing electrodes are crossed and are insulate from each other; and step S2: generating a plurality of touch driving signals by the touch control IC, the number of the touch driving signals being the same as the number of the touch driving electrodes; wherein N number of adjacent touch driving signals are configured to be a signal package, N is a positive integer and is larger than three; applying a composite process to the N number of adjacent touch driving signals within each of the signal packages, such that the N number of adjacent touch driving signals within the same signal package are transmitted to the corresponding touch driving electrodes in a form of sine wave, and the N number of adjacent touch driving signals within the same signal package are sequentially configured to be k stages along a timeline, k is a positive integer and is equal to or smaller than N; in a k-th stage, a phase of a k-th touch driving signals is opposite to the phase of the other (N−1) touch driving signals within the same signal package.

Wherein in the k-th stage, the N number of adjacent touch driving signals within the same signal package include the same number of sine wave peaks.

Wherein any one of the N number of adjacent touch driving signals within the same signal package includes the same number of sine wave peaks in each of the k stages.

Preferably, wherein in the step S2, one signal package includes four adjacent touch driving signals, and the four adjacent touch driving signals in the one signal package are sequentially configured to be four stages along the timeline, and the four stages comprises a first stage, a second stage, a third stage, and a fourth stage.

Wherein in the first stage, the phase of first touch driving signals is opposite to the phases of second touch driving signals, third touch driving signals, and fourth touch driving signals within the same signal package; wherein in the second stage, the phase of the second touch driving signals is opposite to the phases of the first touch driving signals, the third touch driving signals, and the fourth touch driving signals within the same signal package; wherein in the third stage, the phase of the third touch driving signals is opposite to the phases of the first touch driving signals, the second touch driving signals, and the fourth touch driving signals within the same signal package; and wherein in the fourth stage, the phase of the fourth touch driving signals is opposite to the phases of the first touch driving signals, the second touch driving signals, and the third touch driving signals within the same signal package.

Optionally, wherein in the step S2, one signal package includes five adjacent touch driving signals, and the five adjacent touch driving signals within the one signal package are sequentially configured to be five stages along the timeline.

Optionally, wherein in the step S2, one signal package includes six adjacent touch driving signals, and the six adjacent touch driving signals within the one signal package are sequentially configured to be six stages along the timeline.

Optionally, wherein in the step S2, one signal package includes seven adjacent touch driving signals, and the seven adjacent touch driving signals within the one signal package are sequentially configured to be seven stages along the timeline.

Wherein in the step S2, one signal package includes eight adjacent touch driving signals, and the eight adjacent touch driving signals within the one signal package are sequentially configured to be eight stages along the timeline.

In view of the above, the present disclosure provides a touch driving method by replacing the conventional touch driving signals with square wave with the touch driving signals with sine wave, and by applying a composite process to touch driving signals, such that the N number of adjacent touch driving signals within the same signal package are transmitted to the corresponding N number of touch driving electrodes in a form of sine wave, and the N number of adjacent touch driving signals within the same signal package are sequentially configured to be k stages along a timeline; in a k-th stage, a phase of a k-th touch driving signals is opposite to the phase of the other (N−1) touch driving signals within the same signal package. Due that the sine wave is a basic waveform, and is not easily interfered by the harmonic wave, therefore, the touch driving method of the present disclosure may not increase the cost of the touch panel, and may decrease the touch driving signals from generating radiation and electromagnetic interference, so as to effectively increase anti-interference capability of the touch panel.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic diagram of a conventional mutual capacitive touch panel.

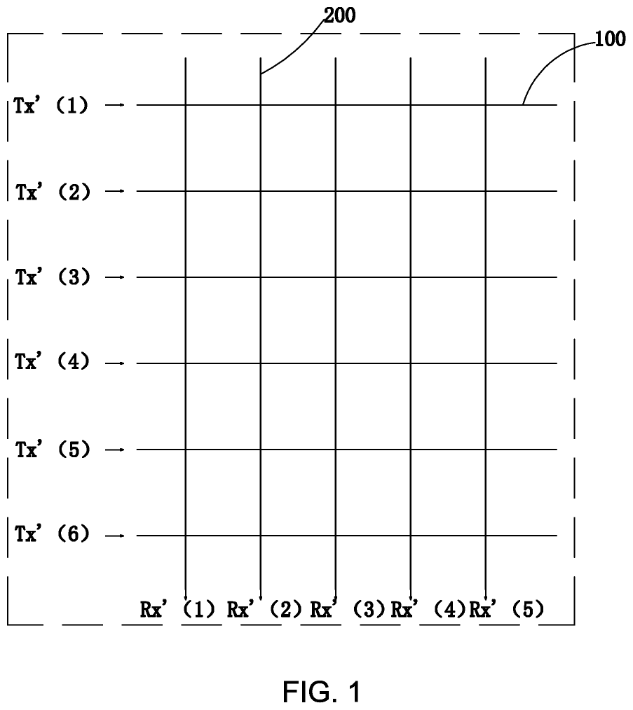

FIG. 2 is a schematic diagram of applying a composite process to the touch driving signals by the touch control IC in the conventional technology.

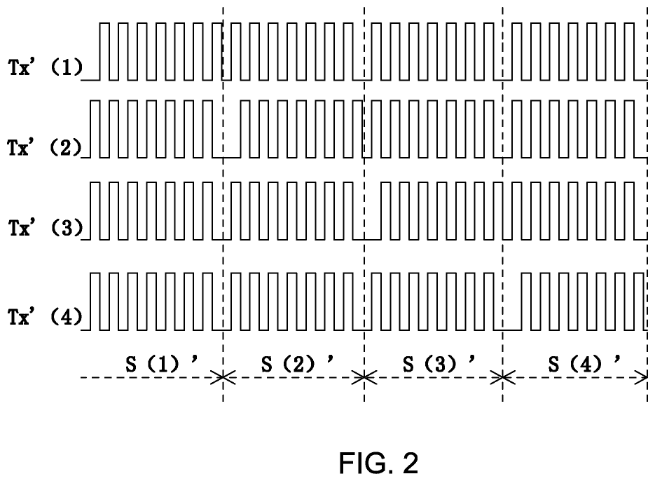

FIG. 3 is a schematic diagram of a Fourier transform for the square wave.

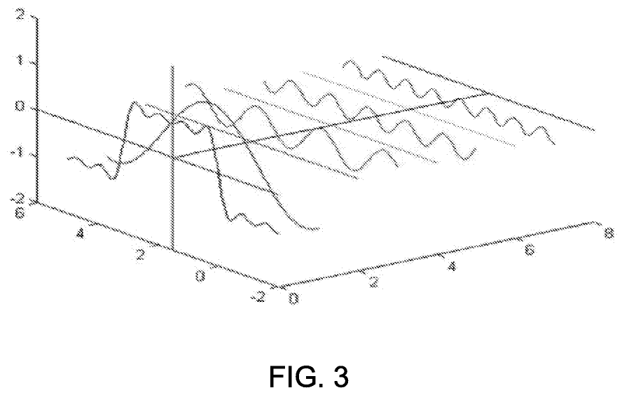

FIG. 4 is a flow chart of a touch driving method in accordance with one embodiment of the present disclosure.

FIG. 5 is a schematic diagram of the step S1 of the touch driving method in accordance with one embodiment of the present disclosure.

FIG. 6 is a schematic diagram of the step S2 of the touch driving method in accordance with one embodiment of the present disclosure.

### DETAILED DESCRIPTION OF PREFERRED EMBODIMENTS

The following descriptions for the respective embodiments are specific embodiments capable of being implemented for illustrations of the present invention with referring to appended figures.

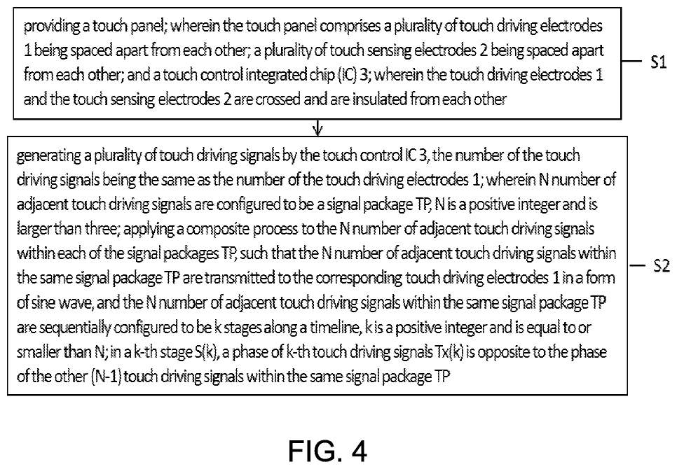

Referring to FIGS. 4-6, a touch driving method is provided in the present disclosure. The touch driving method includes the following steps:

Step 1: providing a touch panel.

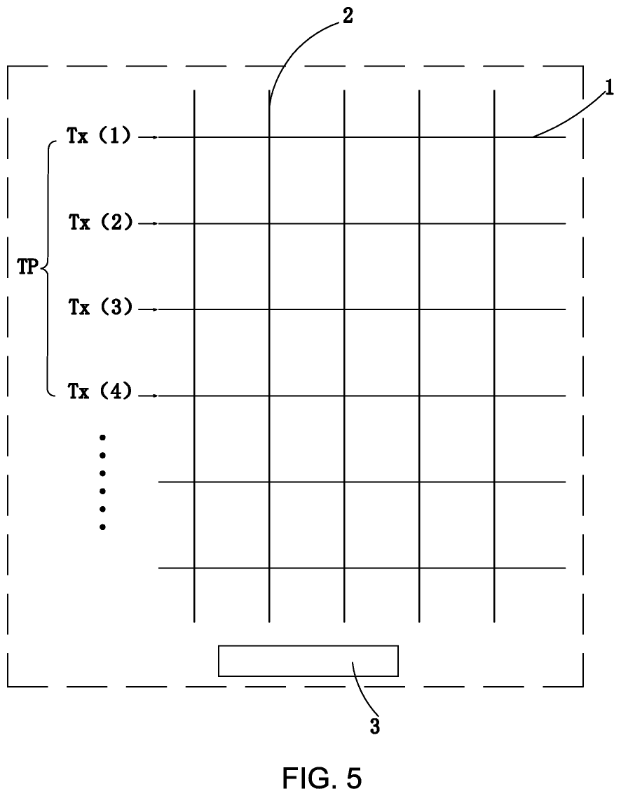

As shown in the FIG. 5, the touch panel includes a plurality of touch driving electrodes 1 being spaced apart from each other; a plurality of touch sensing electrodes 2 being spaced apart from each other; and a touch control integrated chip (IC) 3; wherein the touch driving electrodes 1 and the touch sensing electrodes 2 are crossed and are insulated from each other.

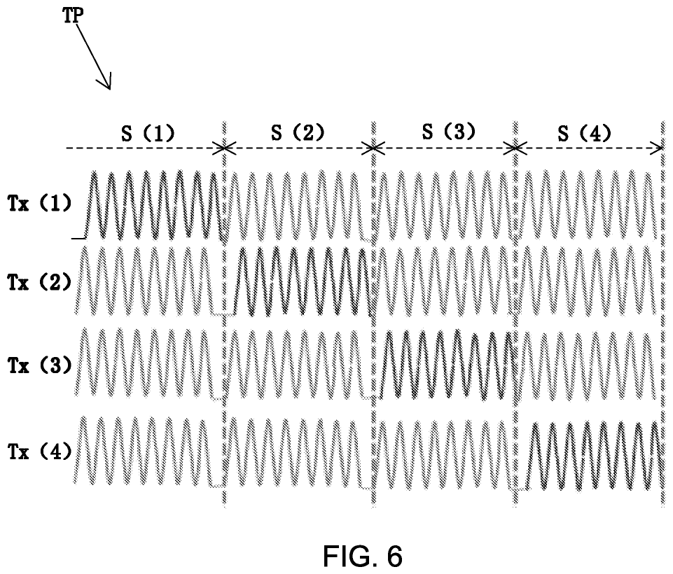

Step 2, referring to FIGS. 5 and 6, generating a plurality of touch driving signals by the touch control IC 3, the number of the touch driving signals being the same as the number of the touch driving electrodes 1; wherein N number of adjacent touch driving signals are configured to be a signal package TP, N is a positive integer and is larger than three; applying a composite process to the N number of adjacent touch driving signals within each of the signal packages TP, such that the N number of adjacent touch driving signals within the same signal package TP are transmitted to the corresponding touch driving electrodes 1 in a form of sine wave, and the N number of adjacent touch driving signals within the same signal package TP are sequentially configured to be k stages along a timeline, k is a positive integer and is equal to or smaller than N; in a k-th stage S(k), a phase of k-th touch driving signals Tx(k) is opposite to the phase of the other (N−1) touch driving signals within the same signal package TP.

Preferably, to assure that the touch control IC 3 has fast processing speed to apply the composite process to the touch driving signals, in the step S2, one signal package includes four adjacent touch driving signals, and the four adjacent touch driving signals within the one signal package TP are sequentially configured to be four stages along the timeline, and the four stages include a first stage S(1), a second stage S(2), a third stage S(3), and a fourth stage S(4).

As shown in FIG. 6, in the first stage S(1), the phase of first touch driving signals Tx(1) is opposite to the phases of second touch driving signals Tx(2), third touch driving signals Tx(3), and fourth touch driving signals Tx(4) within the same signal package TP.

In the second stage S(2), the phase of the second touch driving signals Tx(2) is opposite to the phases of the first touch driving signals Tx(1), the third touch driving signals Tx(3), and the fourth touch driving signals Tx(4) within the same signal package TP.

In the third stage S(3), the phase of the third touch driving signals Tx(3) is opposite to the phases of the first touch driving signals Tx(1), the second touch driving signals Tx(2), and the fourth touch driving signals Tx(4) within the same signal package TP.

In the fourth stage S(4), the phase of the fourth touch driving signals Tx(4) is opposite to the phases of the first touch driving signals Tx(1), the second touch driving signals Tx(2), and the third touch driving signals Tx(3) within the same signal package TP.

Furthermore, in the k-th stage S(k), the N number of adjacent touch driving signals within the same signal package TP include the same number of sine wave peaks. For example, as shown in FIG. 6, in the third stage S(3), all the first touch driving signals Tx(1), the second touch driving signals Tx(2), the third touch driving signals Tx(3), and the fourth touch driving signals Tx(4) include eight sine wave peaks.

Any one of the N number of adjacent touch driving signals within the same signal package TP includes the same number of sine wave peaks in each of the k stages. For example, as shown in FIG. 6, all the first touch driving signals Tx(1) within the same signal package TP in the first stage S(1), in the second stage S(2), in the third stage S(3), and in the fourth stage S(4) include eight sine wave peaks.

Referring FIG. 5 and FIG. 6, in the step S2, one signal package TP may include five adjacent touch driving signals, and the five adjacent touch driving signals within the one signal package TP are sequentially configured to be five stages along the timeline. In the first stage, the phase of first touch driving signals is opposite to the phases of second touch driving signals, third touch driving signals, fourth touch driving signals, and fifth touch driving signals within the same signal package TP. In the second stage, the phase of the second touch driving signals is opposite to the phases of the first touch driving signals, the third touch driving signals, the fourth touch driving signals, and the fifth touch driving signals within the same signal package TP, and so on. In the fifth stage, the phase of the fifth touch driving signals is opposite to the phases of the first touch driving signals, the second touch driving signals, the third touch driving signals, and the fourth touch driving signals within the same signal package TP.

In the step S2, one signal package TP may include six adjacent touch driving signals, and the six adjacent touch driving signals within the one signal package TP are sequentially configured to be six stages along the timeline. In the first stage, the phase of first touch driving signals is opposite to the phases of second touch driving signals, third touch driving signals, fourth touch driving signals, fifth touch driving signals, and sixth touch driving signals within the same signal package TP. In the second stage, the phase of the second touch driving signals is opposite to the phases of the first touch driving signals, the third touch driving signals, the fourth touch driving signals, the fifth touch driving signals and the sixth touch driving signals within the same signal package TP, and so on. In the sixth stage, the phase of the sixth touch driving signals is opposite to the phases of the first touch driving signals, the second touch driving signals, the third touch driving signals, the fourth touch driving signals, and the fifth touch driving signals within the same signal package TP.

In the step S2, one signal package TP may include seven adjacent touch driving signals, and the seven adjacent touch driving signals within the one signal package TP are sequentially configured to be seven stages along the timeline. In the first stage, the phase of first touch driving signals is opposite to the phases of second touch driving signals, third touch driving signals, fourth touch driving signals, fifth touch driving signals, sixth touch driving signals, and seventh touch driving signals within the same signal package TP. In the second stage, the phase of the second touch driving signals is opposite to the phases of the first touch driving signals, the third touch driving signals, the fourth touch driving signals, the fifth touch driving signals, the sixth touch driving signals, and the seventh touch driving signals within the same signal package TP, and so on. In the seventh stage, the phase of the seventh touch driving signals is opposite to the phases of the first touch driving signals, the second touch driving signals, the third touch driving signals, the fourth touch driving signals, the fifth touch driving signals, and the sixth touch driving signals within the same signal package TP.

In the step S2, one signal package TP may include eight adjacent touch driving signals, and the eight adjacent touch driving signals within the one signal package TP are sequentially configured to be eight stages along the timeline. In the first stage, the phase of first touch driving signals is opposite to the phases of second touch driving signals, third touch driving signals, fourth touch driving signals, fifth touch driving signals, sixth touch driving signals, seventh touch driving signals, and eighth touch driving signals within the same signal package TP. In the second stage, the phase of the second touch driving signals is opposite to the phases of the first touch driving signals, the third touch driving signals, the fourth touch driving signals, the fifth touch driving signals, the sixth touch driving signals, the seventh touch driving signals, and the eighth touch driving signals within the same signal package TP, and so on. In the eighth stage, the phase of the eighth touch driving signals is opposite to the phases of the first touch driving signals, the second touch driving signals, the third touch driving signals, the fourth touch driving signals, the fifth touch driving signals, the sixth touch driving signals, and the eighth touch driving signals within the same signal package TP.

Due that the sine wave is a basic waveform, by replacing the conventional touch driving signals with square wave with the touch driving signals with sine wave, the touch driving signals are not easily interfered by the harmonic wave, and by applying a composite process to touch driving signals, such that the N number of adjacent touch driving signals within the same signal package are transmitted to the corresponding N number of touch driving electrodes in a form of sine wave, and the N number of adjacent touch driving signals within the same signal package are sequentially configured to be k stages along a timeline; in a k-th stage S(k), a phase of a k-th touch driving signals Tx(k) is opposite to the phase of the other (N−1) touch driving signals within the same signal package. Therefore, the touch driving method of the present disclosure may not increase the cost of the touch panel, and may decrease the touch driving signals from generating radiation and electromagnetic interference, so as to effectively increase anti-interference capability of the touch panel.

In view of the above, the present disclosure provides a touch driving method by replacing the conventional touch driving signals with square wave with the touch driving signals with sine wave, and by applying a composite process to touch driving signals, such that the N number of adjacent touch driving signals within the same signal package are transmitted to the corresponding N number of touch driving electrodes in a form of sine wave, and the N number of adjacent touch driving signals within the same signal package are sequentially configured to be k stages along a timeline; in a k-th stage, a phase of a k-th touch driving signals is opposite to the phase of the other (N−1) touch driving signals within the same signal package. Due that the sine wave is a basic waveform, and is not easily interfered by the harmonic wave, therefore, the touch driving method of the present disclosure may not increase the cost of the touch panel, and may decrease the touch driving signals from generating radiation and electromagnetic interference, so as to effectively increase anti-interference capability of the touch panel.

Above are embodiments of the present invention, which does not limit the scope of the present invention. Any equivalent amendments within the spirit and principles of the embodiment described above should be covered by the protected scope of the invention.

What is claimed is:

1. A touch driving method, comprising:
step S1: providing a touch panel; wherein the touch panel comprises a plurality of touch driving electrodes being spaced apart from each other; a plurality of touch sensing electrodes being spaced apart from each other; and a touch control integrated chip (IC); wherein the touch driving electrodes and the touch sensing electrodes are crossed and are insulated from each other; and
step S2: generating a plurality of touch driving signals by the touch control IC, the number of the touch driving signals being the same as the number of the touch driving electrodes; wherein N number of adjacent touch driving signals are configured to be a signal package, N is a positive integer and is larger than three; applying a composite process to the N number of adjacent touch driving signals within each of the signal packages, such that the N number of adjacent touch driving signals within the same signal package are transmitted to the corresponding touch driving electrodes in a form of sine wave, and the N number of adjacent touch driving signals within the same signal package are sequentially configured to be k stages along a timeline, k is a positive integer and is equal to or smaller than N; in a k-th stage, a phase of k-th touch driving signals is opposite to the phase of the other (N−1) touch driving signals within the same signal package.

2. The touch driving method as claimed in claim 1, wherein in the k-th stage, the N number of adjacent touch driving signals within the same signal package comprise the same number of sine wave peaks.

3. The touch driving method as claimed in claim 2, wherein any one of the N number of adjacent touch driving signals within the same signal package comprises the same number of sine wave peaks in each of the k stages.

4. The touch driving method as claimed in claim 1, wherein in the step S2, one signal package comprises four adjacent touch driving signals, and the four adjacent touch driving signals within the one signal package are sequentially configured to be four stages along the timeline, and the four stages comprise a first stage, a second stage, a third stage, and a fourth stage.

5. The touch driving method as claimed in claim 4, wherein in the first stage, the phase of first touch driving signals is opposite to the phases of second touch driving signals, third touch driving signals, and fourth touch driving signals within the same signal package;
wherein in the second stage, the phase of the second touch driving signals is opposite to the phases of the first touch driving signals, the third touch driving signals, and the fourth touch driving signals within the same signal package;
wherein in the third stage, the phase of the third touch driving signals is opposite to the phases of the first touch driving signals, the second touch driving signals, and the fourth touch driving signals within the same signal package; and
wherein in the fourth stage, the phase of the fourth touch driving signals is opposite to the phases of the first touch driving signals, the second touch driving signals, and the third touch driving signals within the same signal package.

6. The touch driving method as claimed in claim 1, wherein in the step S2, one signal package comprises five adjacent touch driving signals, and the five adjacent touch driving signals within the one signal package are sequentially configured to be five stages along the timeline.

7. The touch driving method as claimed in claim 1, wherein in the step S2, one signal package comprises six adjacent touch driving signals, and the six adjacent touch driving signals within the one signal package are sequentially configured to be six stages along the timeline.

8. The touch driving method as claimed in claim 1, wherein in the step S2, one signal package comprises seven adjacent touch driving signals, and the seven adjacent touch driving signals within the one signal package are sequentially configured to be seven stages along the timeline.

9. The touch driving method as claimed in claim 1, wherein in the step S2, one signal package comprises eight adjacent touch driving signals, and the eight adjacent touch driving signals within the one signal package are sequentially configured to be eight stages along the timeline.
